(19) United States
(12) Patent Application Publication
(10) Pub. No.: US 2009/0302932 A1
(43) Pub. Date: Dec. 10, 2009

(54) Feeding Arrangement for an Ultrasonic Device

(75) Inventors: Norbert Fröhleke, Paderborn (DE); Christopher Kauczor, Steinhagen (DE); Rongyuan Li, Paderborn (DE)

Correspondence Address: BIRCH STEWART KOLASCH & BIRCH, PO BOX 747, FALLS CHURCH, VA, 22040-0747, US

(73) Assignee: UNIVERSITAT PADERBORN, PADERBORN (DE)

(21) Appl. No.: 12/226,987

(22) PCT Filed: Apr. 30, 2007
(86) PCT No.: PCT/DE2007/000773

§ 371 Date: Jun. 23, 2009

(30) Foreign Application Priority Data
May 8, 2006 (DE) 10 2006 021 559.1

(51) Int. Cl. H04B 1/10

(52) U.S. Cl. 327/551

(57) ABSTRACT

The invention relates to a powerful 3-point inverter that is triggered by a pulse width modulator (5). The generated inverter voltage (Upwm) is used as an input signal for the LLCC bandpass filter (8) comprising a parallel inductor (Lp) that is arranged parallel to the ultrasonic device and a series resonant circuit (6) containing at least one series inductor (L5) and at least one series capacitor (C5). The LLCC filter additionally comprises the transformer (T) to isolate the potential while also comprising a cable if the ultrasonic actuators are placed at a certain distance such that a low-harmonic, broadband actuator voltage can be generated. The filter utilizes the capacity of the ultrasonic actuator (Cp), the capacity of the cable if a connecting cable is required, and the leakage inductance of the transformer.

This present invention relates to a feeding arrangement for an ultrasonic device according to the preamble of Patent Claim 1.

Prior known from DE 44 46 430 A1 is a triggering arrangement for an ultrasonic device in the form of an ultrasonic transducer which comprises a control means having a network consisting of inductors and capacitors. The network comprises a series resonant circuit whose resonance frequency is tuned to the frequency of a rectangular signal provided by a rectangular pulse wave generator. The frequency of the rectangular pulse wave generator simultaneously determines the frequency of a sine oscillation that is imparted to the ultrasonic device. This prior art triggering arrangement is affected by the drawback that the circuit arrangement is rated for low capacities and that due to heavy loading of the transistor and the capacitor disposed between two coils it cannot be scaled up to the capacity required according to this present invention either. The circuit arrangement additionally needs to have a variable voltage.

DE 100 09 174 A1 discloses a triggering arrangement for an ultrasonic device in which a control means generates a pulse width modulated signal for said ultrasonic device. Such a pulse width modulated signal may for instance be provided by a pulse width modulation transducer of the type known from an article entitled “Inverter Topologies for Ultrasonic Piezoelectric Transducers with High Mechanical Q Factor” by C. Kauczor and N. Fröhleke, Proc. of IEEE Power Electronics Specialists Conference (PESC) 2004. This paper describes the advantages and drawbacks of various arrangements for feeding ultrasonic devices. The first variant therein described relates to a feeding device with an LC transducer wherein an inductor is arranged in series with the capacitively acting ultrasonic device. This series resonant circuit is triggered by a circuit frequency that is close to the resonance frequency of the ultrasonic device. An advantage here is that harmonic distortions can be kept low. An alternate feeding arrangement may comprise a so-called LLCC transducer which comprises a parallel inductor placed close to the ultrasonic device and a series resonant circuit. It is an advantage of this arrangement that said transducer is capable of strongly reacting to capacity fluctuations of the ultrasonic device while disadvantages thereof are that more severe strains are imparted to the transducer components and that greater harmonic distortions are involved. A third variant of a feeding arrangement that has been investigated is a pulse width modulator (PWM)) which advantageously permits variable resonance frequency settings. In addition, the components of the modulator may be of smaller size and lower weight while disadvantages thereof are relatively high switching losses and the extent of cooling needed for the modulator components due to higher switching frequencies. The feeding arrangements described in the article pertain exclusively to ultrasonic devices having a relatively high mechanical resonance property Qm.

It is an object of this present invention to improved a feeding arrangement for an ultrasonic device in such a way that the efficiency and compactness thereof will be improved and particularly that distortions of the harmonics will be kept low and a local reactive power compensation will be ensured.

To achieve this object the present invention in conjunction with the preamble of Patent Claim 1 is characterized by the fact that the feeding arrangement comprises an LLCC filter having an inductor that is arranged parallel to the ultrasonic device and a series resonant circuit containing at least one series inductor and at least one series capacitor.

It has been surprising to find that a combination consisting of a pulse width modulator (PWM) and an LLCC filter increases the compactness of the feeding arrangement in spite of the fact that the number of components used therein is larger. It is an advantage that the components of the feeding arrangement of this present invention may be of smaller dimensions since the pulse width modulator (PWM) imposes a lower electric load thereon. The parallel arranged inductor permits to achieve compensation of the reactive power component of the ultrasonic device such that the structural elements, for instance those of the series resonant circuit and the cable for connecting the actuator in case of remote arrangement may be of smaller dimensions because of the lower load involved. The combination of the pulse width modulator PWM with the LLCC filter advantageously permits that to tune the feeding arrangement to different ultrasonic devices it may be varied and/or trimmed with different frequencies to characterize same by high-level signal excitation and to find out what are the optimal resonance modes thereof. Any finite element analysis requiring a great deal of resources is not necessary in that case. The resultant advantage is an optimized tuning between the feeding arrangement and any ultrasonic device whatsoever.

The pulse width modulator (PWM) advantageously enables the feeding arrangement to act as an AC voltage source with relatively low internal resistance so that the transfer function of the ultrasonic device is not subject to heavy fluctuations in the transmission band and the design of the power section and the control portion is facilitated. Moreover, the weight and the costs of the power section may be reduced due to the load reduction involved. In addition does the immunity of the filter to interferences of the piezoelectric capacitor Cp due to different types and temperature influences on the actuator make the design of the power and the control portion substantially easier.

According to a modification of the invention (Claim 4) the resonance frequency of the overall resonant circuit may conform to an integer multiple of the resonance frequency of a parallel resonant circuit and/or to the working frequency of the ultrasonic device which permits the components of the series resonant circuit of the LLCC filter to be kept relatively small and also improves the dynamic behavior.

Further advantages of the invention are as disclosed in the subclaims.

One exemplary embodiment of this present invention shall now be described in closer detail with reference to the accompanying drawings.

In these drawings:

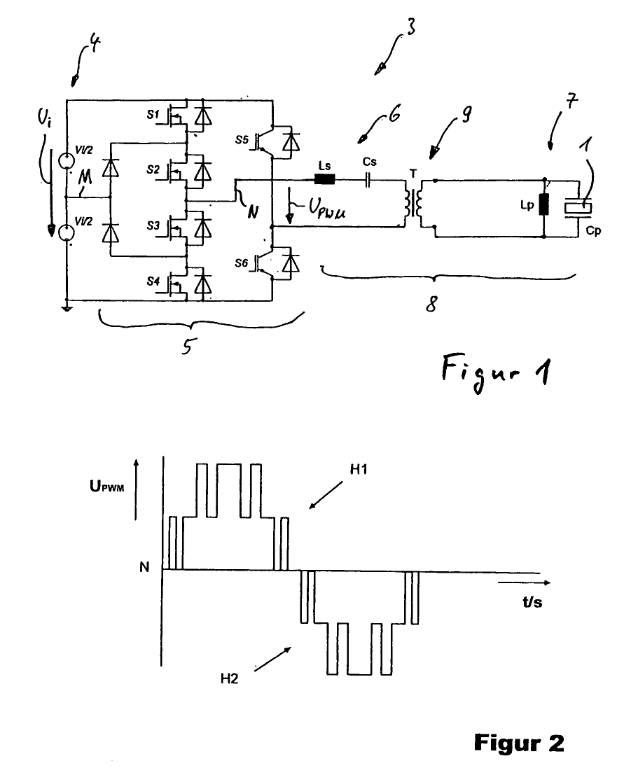

FIG. 1 is a schematic circuit diagram of a feeding arrangement for ultrasonic actuators;

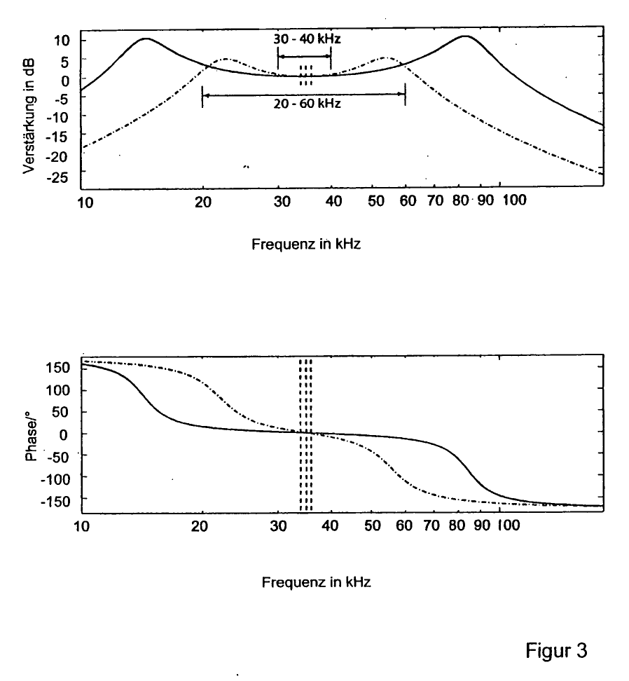

FIG. 2 shows an output voltage signal of a pulse width modulator PWM (PWM output voltage) of the feeding arrangement; and

FIG. 3 is a Bode's diagram for a prior art feeding arrangement comprising just one pulse width modulator PWM (dot-and-dash line) and for a feeding arrangement containing a pulse width modulator PWM with LLCC filter according to the present invention.

A feeding arrangement for an ultrasonic device 1 of this present invention is shown in FIG. 1. The ultrasonic motor may be used as a direct drive in aircrafts, motor vehicles, robot equipment units and medical measuring system appliances and is allocated to the group of medium damped piezoelectric vibration systems. The ultrasonic device 1 may be provided as an ultrasonic transducer or an ultrasonic generator with a sonotrode also for ultrasound assisted cutting, chiselling, milling, welding and such like in which case it is allocated to the group of low damped piezoelectric vibration systems.

The ultrasonic device 1 (commonly referred to as ultrasonic actuator in technical literature) has a piezoelectric capacitor C_{P} as capacitive Consumer which is preceded by a feeding arrangement 3.

The feeding arrangement 3 is connected to a DC voltage source 4 having an output voltage U₁. The feeding arrangement 3 comprises a pulse width modulator (PWM) 5 which is connected to the DC voltage source 4 and which provides as PWM output voltage U_{PWM} a pulse width modulated signal for a downstream series resonant circuit 6. As shown in FIG. 1, the PWM 5 may consist of a 3-point inverter or of a 2-point inverter (H-type full bridge) triggered according to optimized pulse patterns.

The series resonant circuit 6 consists of a series inductor L_{S} and a series capacitor C_{S} which together with a parallel resonant circuit 7 are forming an LLCC filter 8 (overall resonant circuit). The parallel resonant circuit 7 is constituted by the capacitor C_{P} of the ultrasonic device 1 and a parallel inductor L_{P} arranged parallel to said latter.

The LLCC filter 8 additionally comprises a transformer 9 between the series resonant circuit 6 and the parallel resonant circuit 7.

The pulse width modulator (PWM) 5 has four series connected transistors S1, S2, S3, S4 each having a diode arranged in parallel. The transistors S1, S2, S3, S4 are provided in the form of normally-off N-channel MOS-FET transistors. A down-stream parallel branch is formed by two series connected transistors S5, S6 provided as insulated gate bipolar transistors (IGBTs) each having a diode arranged parallel therewith. A source connection of the second transistor S2 forms the positive input terminal for the LLCC filter 8. An emitter connection of the transistor S5 forms the negative input terminal for said LLCC filter 8.

Referred to a mean reference potential N does triggering of the transistors S1, S2, S6 permit to produce a positive half-period H1 and triggering of transistors S3, S4, S5 to provide a negative half-period H2 as shown in FIG. 2. The two different steps of half-periods H1, H2 are obtained dependent on whether S1 or S2 and/or S3 or S4 will be triggered. The connections between Transistors S1 and S2 as well as S3 and S4 are joined to a central connector M of the input voltage source U₁ by means of one diode each.

The voltage signal U_{PWM} present at the output of the pulse width modulator (PWM) 5 is a high-frequency signal whose base frequency is coincident with the resonance frequency of the ultrasonic device 1.

A transfer function as shown in FIG. 3 (solid line) is obtained in conjunction with the LLCC filter 8 and a relatively broad operating range between 20 kHz and 60 kHz is ensured by the 3-point inverter (modulator (PWM) 5) in spite of a relatively low switching frequency as compared with a 2-point inverter approach (H-type full bridge). Triggering the ultrasonic device 1 by a monopulse H-type full bridge (refer to the initially mentioned paper by Kauczor/Fröhleke) provides the transfer function which is shown in dot-and-dash line representation in FIG. 3 and which affords an operating range in a frequency band of just 30 kHz and 40 kHz. The feeding arrangement of this present invention advantageously ensures immunity to parameter variations, in particular to changes of the capacitor C_{P} of ultrasonic device 1.

The pulse width modulator (PWM) 5 is to be triggered in such a way that the switching frequency thereof and/or the frequency of the output voltage U_{PWM} from said modulator 5 conforms to the working frequency of the ultrasonic device 1. To compensate the reactive power of the ultrasonic device 1 the parallel inductor L_{P} of the parallel resonant circuit 7 is tuned to the parallel capacitor C_{P} and to the working frequency f_{M} of the ultrasonic device 1. The parallel inductor is calculated to the formula below:

$${L}_{P} = \frac{1}{{C}_{P} * {( 2 {f}_{M} )}^{2}}$$

The second resonance frequency fₒ₂ of the overall resonant circuit 8 may be an integer multiple of the resonance frequency of the parallel resonant circuit 7, for instance three times the frequency f_{w}. The series inductor L_{S} and the series capacitor C_{S} will be calculated as follows in that case:

$${L}_{S} = \frac{{L}_{P}}{{L}_{P} {{C}_{P} ( 2 {f}_{02} )}^{2} - 1}$$

$${C}_{S} = {C}_{P} \frac{{L}_{P}}{{L}_{S}}$$

The invention is hence particularly related to a powerful 3-point inverter that is triggered by a pulse width modulator (see FIG. 2). The generated inverter voltage serves as an input signal for the LLCC bandpass filter which to isolate the potential additionally comprises a transformer as well as a cable also if the ultrasonic actuators are placed at a certain distance such that a low-harmonic broadband actuator voltage is generated. The filter utilizes the capacity of the ultrasonic actuator, the capacity of the cable and the leakage inductance of the transformer.

1. Feeding arrangement for an ultrasonic device comprising a pulse width modulator by means of which a pulse width modulated voltage (U_{PWM}) is generated, characterized by the fact that the feeding arrangement (3) includes an LLCC filter (8) comprising a parallel inductor (L_{P}) that is arranged parallel to the ultrasonic device (1) and a resonant circuit (6) containing at least one series inductor (L_{S}) and at least one series capacitor (C_{S}).

2. Feeding arrangement according to claim 1, characterized by the fact that the parallel inductor (L_{P}) forms a local parallel resonant circuit (7) in coaction with a piezoelectric capacitor (C_{P}) that electrically represents the ultrasonic device.

3. Feeding arrangement according to claim 1, characterized by the fact that the parallel inductor (L_{P}) is tuned to the working frequency of the ultrasonic device (1).

4. Feeding arrangement according to claim 1, characterized by the fact that the second resonance frequency (f₀₂) of the overall resonant circuit (8) is an integer multiple of the resonance frequency of the parallel resonant circuit (7) and/or corresponds to the working frequency of the ultrasonic device (1).

5. Feeding arrangement according to claim 1, characterized by the fact that a transformer (9) is arranged between the series resonant circuit (6) and the parallel resonant circuit (7).

6. Feeding arrangement according to claim 1, characterized by the fact that the pulse width modulator PWM (5) comprises four transistors (S1, S2, S3, S4) of MOSFET type such that five different voltage levels are generated to generate the high-frequency PWM output voltage (U_{PWM}).

7. Feeding arrangement according to claim 1, characterized by the fact that the ultrasonic device (1) is in the form of an ultrasonic motor or an ultrasonic transducer.
